(19) United States
(12) Patent Application Publication
(10) Pub. No.: US 2010/0070160 A1
(43) Pub. Date: Mar. 18, 2010

(54) METHOD FOR DETECTING DEFECTS IN NAVIGATION DATA

(76) Inventors: Niko Haatainen, Nilsia (FI); Vesa Suontama, Espoo (FI); Samuli Mattila, Berlin (DE); Miika Lappalainen, Berlin (DE)

Correspondence Address: FAY SHARPE LLP, 1228 Euclid Avenue, 5th Floor, The Halle Building, Cleveland, OH, 44115, US

(21) Appl. No.: 12/159,114

(22) PCT Filed: Dec. 27, 2006
(86) PCT No.: PCT/FI2006/000423

§ 371 Date: Nov. 30, 2009

(51) Int. Cl. G01C 21/36

(52) U.S. Cl. 701/201

(57) ABSTRACT

A navigation system using a mobile terminal (14), GPS receiver (13), navigation server (15) and navigation software, wherein the navigation software is arranged to detect defects in navigation or driving conditions data. Defects in the navigation or driving conditions data are detected by comparing the actual behavior of the user with the route computed and sug-gested by the navigation software. The difference be-tween the actual route taken by the user and the com-puted route is detected and sent to the navigation server (15). The navigation server (15) then collects statistical information on such locations on the map where users repeatedly choose a different route from the computed route and determines, based on the sta-tistics, the possible defect in the navigation or driving conditions data.

### FIELD OF THE INVENTION

The invention relates to navigation devices. The invention is particularly related to detecting defects in navigation data of the navigation devices.

### BACKGROUND OF THE INVENTION

Navigation systems have been developed for assisting drivers to reach a desired destination. The user of such a system inputs the desired destination to the navigation device. As a response the system requests the current location coordinates of the navigation device from a positioning device, which is typically a GPS receiver. The navigation device then computes the route from the current location to the destination. The user of a navigation device is guided to the destination, for example, via the fastest route. The guiding procedure may include informing the user of the distance to the next turn or whether the next turn is to the right or left. During the guiding procedure the location of the user is monitored and, if necessary, a new route is computed. Computing a new route might be required for example if the user misses a turn and the directions are no longer valid.

Traditionally navigation devices comprise all the information and software required for computing the route even if the navigation device is, as in most cases, a cellular phone or a PDA device that has network connectivity means. This kind of implementation is known as on-board design. In off-board implementations the route is computed in a separate navigation server that sends the information back to the navigation device. Both of the implementations have their benefits and most likely a hybrid implementation with combination of on-board and off-board characteristics will be preferred in the future.

FIG. 1 presents an illustration of an off-board navigation system. In the navigation system of FIG. 1 an external server 15 includes all navigation data and computing means for providing guidance for the navigation device 14. However, the navigation device 14 may just as well have all the information and software required for computing and providing the route information. In the example of FIG. 1 the navigation device 14 does not have a built-in positioning device but is connected wirelessly to a GPS receiver 13 that computes the exact location of the receiver 13 from the observations received from the GPS-satellites 10, 11 and 12. For understanding also the present invention better, it should be understood that navigation devices, particularly such mobile phones that are equipped with navigation software and positioning means, are capable of executing software applications. Thus, the navigation device has common means required for executing a program, such as a central processing unit and a memory. However, these are common features in present navigation and mobile devices and are not presented herein as they are well known to a person skilled in the art.

Inevitably, the navigation data has some defects especially when circumstances on a road have changed. A road may e.g. have been changed from a one-way road into a normal bi-directional road or if there used to be a “no right turn” sign in a junction that has been later removed. Updating navigation data is, therefore, not an easy task because one has to keep track of all changes happening on the road network. The changes may be permanent as well as temporary. A temporary change on the road network may be a road construction that will block a road for a while but will later be opened for traffic again. It is also possible that the navigation data was originally coded wrongly. A bi-directional road may have been marked as a one-way road in the navigation data or there may be a “no right turn” marked on the data in a place where there is not a corresponding sign on the road.

More advanced implementations of navigation devices can use additional information for routing purposes. The most beneficial types of additional information relate to road conditions. These include for example, traffic and weather information that might cause traffic jams or other delays in a journey. This kind of information changes rapidly. For example, a car crash on a highway might stop the traffic immediately causing a navigation fault, as the route must be changed if there is an alternative possibility.

These defects in the navigation data are difficult to notice or correct. They might have been erroneously input when coding the map into navigation data or they might result from unpredicted changes in the road network. In any event, due to their unexpected nature, these defects and errors in the navigation data tend to surface especially in such cases in which the user knows the fastest route himself and is directed via a longer one. The user finds these errors inconvenient and therefore, they also affect the usability of the navigation device.

### PURPOSE OF THE INVENTION

The purpose of the invention is to provide a reliable procedure for detecting errors and defects in navigation data of navigation systems.

### SUMMARY OF THE INVENTION

The invention discloses a method for detecting defects in navigation data. The invention further discloses a system and software for navigation devices with a navigation database.

It is assumed that the users of navigation devices will follow the computed route. The computed route may comprise the actual driving directions, speed limits and other restrictions that are significant in routing decisions and in estimating the advancing on the route. In the method according to the present invention, defects in the navigation data are detected by comparing the actual behavior of the user with the route that is assumed to be followed and suggested by the navigation software. The method further comprises the steps of detecting a difference between the actual behavior of the user and the assumed route and sending the detected difference to a receiving unit, which can be, for example, a navigation server or another navigation device. The difference can be a completely different route, different speed on the assumed route or the like. Furthermore, it is possible that the navigation device collects a plurality of defects before sending. For example, if the network is not available at the moment of the defect, the plurality of collected defects is sent when the network is available again. The navigation server then collects statistical information on such locations on the map where users repeatedly choose a different route from the Computed route and determines based on the statistics the possible defect in the navigation data. A threshold may be set e.g. for the number of times that users choose an alternate route. The threshold may as well be set to a certain percentage of the users driving another route. When the threshold is exceeded, the software concludes that there must be an error in the navigation data. The navigation data provider may also be informed of the possible defects. Depending on the nature of the noticed defect, he may then check whether the defect must be corrected and navigation data updated. The possible defect can be a major change in the road network that needs to be corrected in the navigation data or it can be a change in traffic or weather data that can be corrected automatically. For example, if a traffic jam has been reported but vehicle speeds are normal, there must be an error in traffic information and it can be corrected automatically or an automatic correction is suggested that needs to be verified by the service operator.

In a preferred embodiment of the error detecting method, comparing the actual route taken by the user with the computed route is done continuously as the user proceeds towards the destination. In another preferred embodiment, comparing the actual route taken by the user with the computed route is done after the guidance procedure.

The invention designed is particularly suitable for mobile phones that are equipped with navigation software and positioning means. Furthermore, the navigation device has common means required for executing a program, such as a central processing unit and a memory. However, these are common features in mobile devices and are not presented herein as they are well known to a person skilled in the art. The navigation device can also be some other kind of communications device enabled to communicate the computed route to the user. In such an example, there must be some data communications means available for the device and the navigation server to communicate.

In an embodiment of the invention the noticed differences are shared by using a peer to peer protocol. This type of sharing may be additional to using the server based implementation or independently. This information can be received from all users or from a group of predetermined users. The reliability of the received information can be improved by requiring several notifications. For example, if a traffic jam is reported, the navigation device waits for second notification as a confirmation to the first report. The user can define the number of required notifications.

The benefit of the invention is that it provides a simple and reliable error detecting procedure for navigation devices and systems. Defects in the navigation and additional data are perceived faster and easier than in prior art navigation systems. The invention further reduces the map provider's time-consuming task of searching for errors in the navigation data as well as the updating procedure of such data. Furthermore, a fast correction of the additional data will help the user in reaching the desired destination and also makes the traffic more fluent. A further benefit of the present invention is that while it facilitates the updating procedure, it also enables improving the quality of navigation data in navigation devices and systems. It is also a user-friendly method for detecting errors since it can be done in the background without the need for user interaction.

### BRIEF DESCRIPTION OF THE DRAWINGS

The accompanying drawings, which are included to provide a further understanding of the invention and constitute a part of this specification, illustrate embodiments of prior art as well as the present invention. The figures, together with the description, help to explain the principles of the invention. In the drawings:

FIG. 1 is an illustration of an example embodiment of a prior art navigation system,

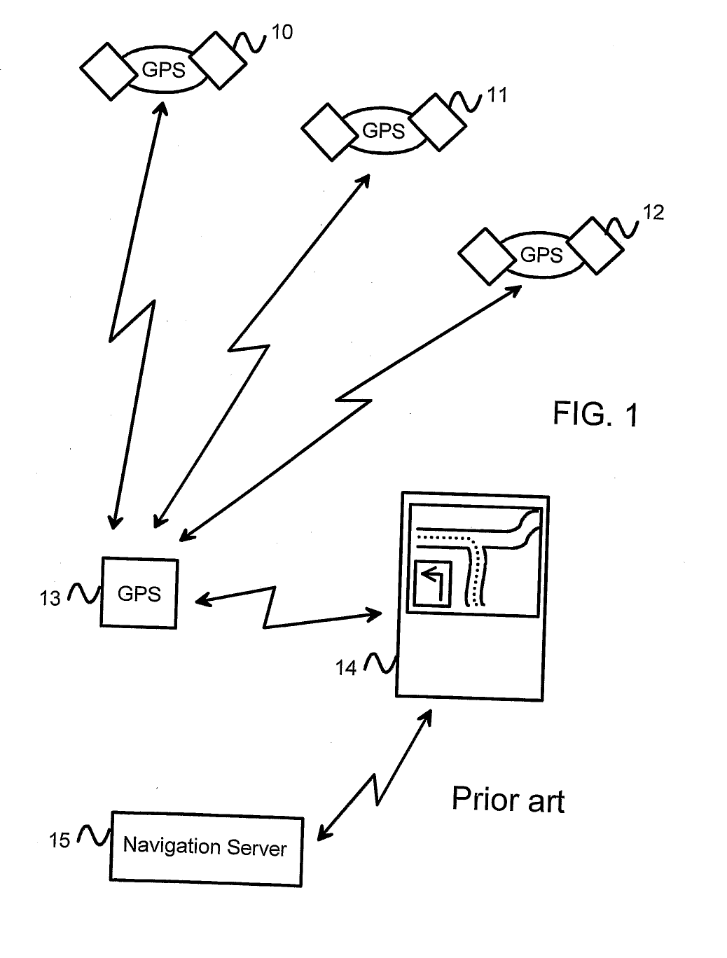

FIGS. 2a and 2b present an illustration of navigation data in weighted graph form,

FIGS. 3a and 3b present an illustration of a road network and the user's route, and

FIG. 4 is a flow chart of a method according to the present invention.

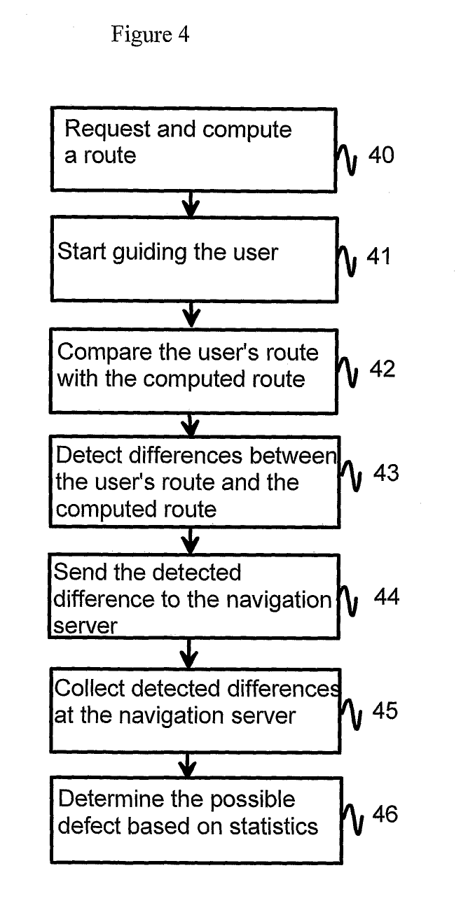

### DETAILED DESCRIPTION OF THE INVENTION

Reference will now be made in detail to the embodiments of the present invention, examples of which are illustrated in the accompanying drawings.

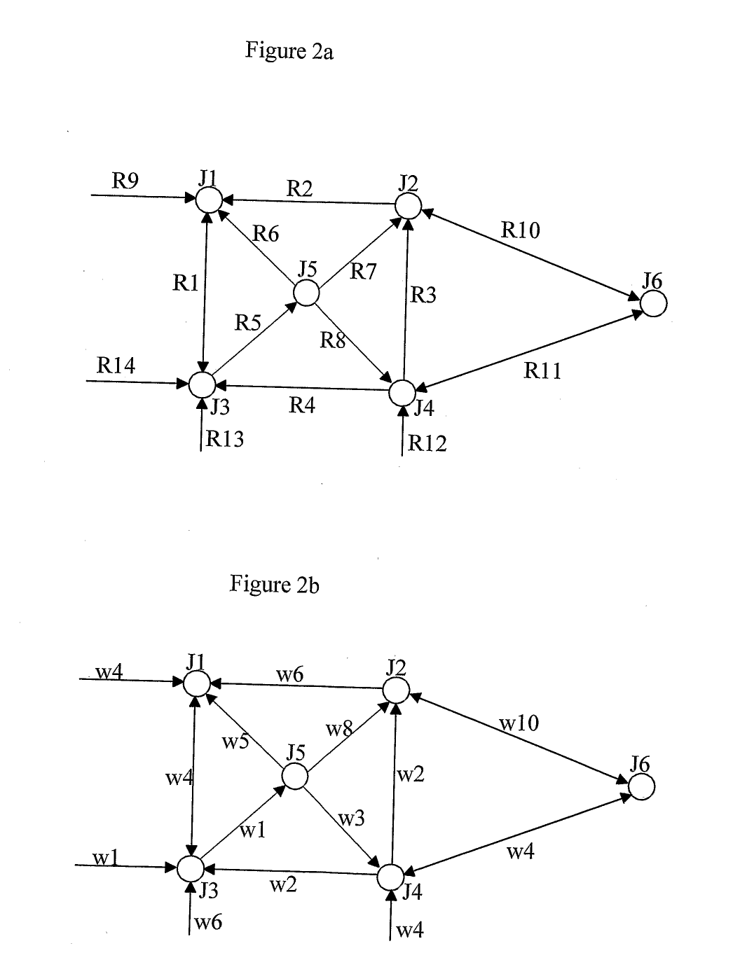

To understand better the procedure for detecting defects in navigation data first one must know how the navigation material is organized. The navigation material comprises map information that is required for guiding the user of the device. The map material comprises geometry, topology, address and other information, such as traffic signs, that may be used during guidance. The actual road information is usually coded in the form of weighted graphs. The graph consists of vertices (or nodes) that are connected by lines called edges (or arcs). The vertices in the graph correspond to road junctions of a map and the connecting lines between the vertices respectively correspond to the roads. The connecting lines i.e. the edges are assigned a direction and a weight that may e.g. represent the complexity or the length of a road. FIGS. 2a and 2b provide an example of a directed graph corresponding to a road network. In addition to the above-mentioned information the navigation device may use additional information that is retrieved from the network, for example, traffic, weather information or other temporary information.

The user of the navigation device inputs the desired destination such as the location corresponding to vertex J6 in FIGS. 2a and b. As a response the system computes e.g. the shortest route from the user's current position to the desired destination and starts guiding the user to the destination. If the user is at junction J1, the device guides the user to take the shortest possible way via roads R1, R5, R8 and R11. The user must drive via junction J5 because road R4 is a one-way road in the wrong direction. The navigation software computes the best route from the point of origin to the destination according to the predetermined rules, for example by minimizing the weight of the route. In this example (FIG. 2b), the user could also be guided via roads R1, R5, R7 and R10 but this route would have much higher weight and it would, therefore, take longer than the route offered by the navigation device.

If the user/users of the navigation device choose another route than the one computed and suggested by the navigation software, the navigation device detects this difference by comparing the user's actual route with the computed route. It is assumed that the user of the device will follow the computed route. If the actual behavior of the user differs from the assumed route, the device sends the detected difference to the navigation server. This difference can be a completely different route or, for example, a difference in assumed speed of the navigation device. The navigation device may also inquire the user whether he wants to send the notification to the server but advantageously, the notification is sent without any interaction needed from the user. Based on the notifications on the differences between the actual routes and the computed routes, the navigation server collects information on the routes taken by the users and keeps track of the statistics on such locations where the actual route taken by the user differs from the suggested route. It is possible to monitor continuously whether the route taken by the users differs from the computed one. It is just as well possible for the navigation server to keep record of the users' routes and afterwards compare the actual route taken by the user with the given directions. For example, if the users repeatedly drive in the wrong direction on a road that is marked as a one-way road on the navigation data, the software may conclude that the marked road in fact is a two-way road. Similarly, the users may choose a different route e.g. if the road is blocked because of a temporary road construction or because of any other changes in the road network.

If, for example, a certain percentage of the users drive differently from the directions given by the navigation device, the navigation software may notify the navigation data provider of this event. The navigation data provider checks and approves the notification. He may send someone in person to check if the circumstances on the road have changed and if so, whether the changes are permanent or temporary (such as in case of a road construction). He may also conclude that the defect was in the navigation data in the first place and update the data based on his observations.

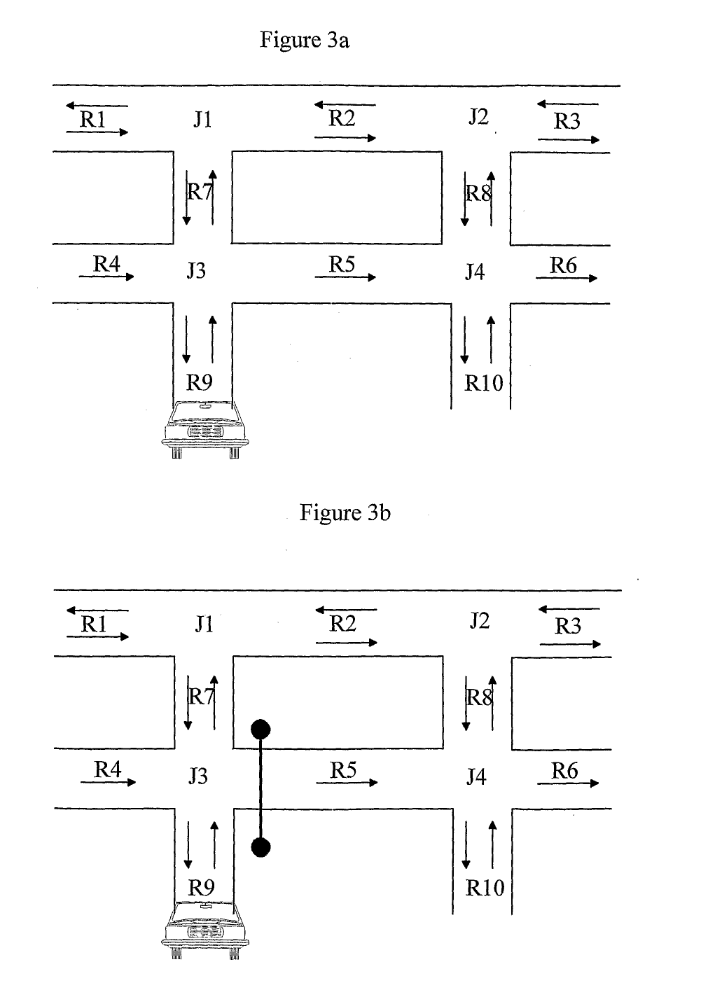

An example of the defect detecting procedure according to the present invention is disclosed in FIGS. 3a and 3b. When the user is on road R9 in FIG. 3a and enters road R6 as his destination, the navigation software computes the optimum route to be via route R5 and starts guiding the user to turn right at junction J3. However, if road R5 has been blocked by e.g. a road construction (FIG. 3b), the user must choose the route via roads R7, R2, R8 and R6. As the user passes his guided turn at junction J3 to road R5, the navigation device detects this discrepancy and sends the difference to the navigation server. An alternate route is then computed to the user driving already on road R7 via roads R2 and R8 to the destination route R6. The navigation server collects information on all such events when a user chooses another route than the one suggested by the device itself. If a number of users choose this same alternate route, the navigation software concludes that there must be a defect in the navigation material and makes a further notification.

The defect detecting procedure is initiated automatically so that typically the user does not even notice it. In a method according to the invention the method is initiated by requesting and computing a route, step 40. This is a common feature of navigation devices as their purpose is to guide a user of the device from the current location to a desired destination. After computing the route the navigation device starts guiding the user, step 41. The computed route is assumed to be followed by the user. Thus, the user can start driving. When the guiding is started, the device monitors the location of the user and compares the actual route taken by the user with the computed route 42. When the device detects a difference between the actual behavior of the user and the computed route 43, it sends the difference to the navigation server 44. The navigation server collects each detected difference 45 and sets a limit value for how many times the user's route differs from the computed route at the same location. When e.g. the users take a different route a certain number of times or a certain percentage of the users take a different route, then the navigation software concludes that there must be a defect in the navigation data at the location where these two routes differ. The software may also notify the navigation data provider who can update the data. If the navigation data has been already updated and the reporting user has an old version of the database, the service provider may send an update or a notification of an available update.

In a preferred embodiment the implementation comprises a mobile phone that is capable of executing a navigation software application. The navigation device has been connected to a GPS receiver with a wireless connection, such as Bluetooth, or has been built into the navigation device. The GPS system is mentioned because it is most commonly used, exact and because there are plenty of hardware implementations. However, for the error detecting procedure according to the present invention any kind of positioning system is acceptable. The navigation database is stored on a memory card. The navigation software is arranged to monitor or keep record of the routes chosen by the user and compare the routes with the navigation data in the device. The essential feature of the defect detecting procedure is the comparing of the actual route taken by the user with the given directions and determining, based on statistics, if there is a defect in the navigation data.

In an alternative preferred embodiment the implementation further comprises using the additional information regarding driving conditions on a route, such as traffic or weather information. Driving conditions data may and should be used in routing decisions in order to reach the best possible routing solution. This information changes rapidly and is subject to similar defects as described above. For example, when an traffic jamming accident occurs and it is not known in the additional information, firstly, it must be reported. When the speed limit and actual speed of the vehicle are known, it is easy to compute that the vehicle is not moving as expected. In this case, the navigation device sends a notification to the service provider providing the traffic information. In case of heavy traffic it is likely that there will be more than one report. When the number of reports fulfils a certain threshold in a predetermined time period, the additional information is changed. The change can be automatic or a notification to an operator who verifies the suggested change. Lastly, the change is reported to customers that are in the area, broadcasted to customers or dispatched in some other suitable way. Respectively, if a traffic jam is reported and the cars are moving considerably faster, the traffic information might be old and the reason for the jam no longer exists. Also in this case the noticed difference is sent to the service operator for further processing. Similar procedures can also be used for weather information, such as flooding, avalanches, wind or any other weather observations that might cause restrictions to roads, passes, bridges or the like.

In a further alternative embodiment a peer to peer protocol is used for sharing the information. In this embodiment the noticed defects are not sent to a server but shared directly to other users by sending the information directly to another navigation device. Respectively the updates are received directly from other navigation devices. This is particularly useful with the traffic conditions information sharing. In this case, if desired, the statistical analysis needs to be implemented in the navigation device. However, it is possible to use received information also without statistical analysis. Furthermore, it is possible to combine these methods of sending and receiving the information. Thus, the users can get the benefits by using both channels.

When using a navigation application according to the present invention, the defect detecting procedure can be totally independent and automatic and it does not require further interaction from the user of the navigation device. The user requests a route to be computed as usual. The navigation device acquires the position of the device and then computes the route. The device may then start a continuous error detecting procedure directly after computing the route. The server may collect only the locations on the map where the user takes another route than the one suggested by the device. The server may also collect information on the actual routes taken by the user and compare them with the navigation data later. After a certain threshold for the number of times that users choose an alternate route at the same location, the navigation data provider may be informed of the possible defect in the navigation data.

It is obvious to a person skilled in the art that with the advancement of technology, the basic idea of the invention may be implemented in various ways. The invention and its embodiments are thus not limited to the examples described above; instead they may vary within the scope of the claims.

1. A method for automatically detecting defects in navigation data in a navigation system comprising navigation data, which method comprises the steps of:
computing a route (40) from the current position to a destination upon request; and
guiding the user of the navigation device (41) according to said computed route;
characterized in that the method further comprises steps:
comparing the actual behavior of the user with the computed route (42);
detecting at least one difference between the actual behavior of the user and the computed route (43);
sending detected differences to a receiving unit (44);
collecting detected differences at the receiving (45); and
determining based on the statistics the possible defect in the navigation data (46).

2. A method according to claim 1, characterized in that the method further comprises the step of:
notifying the navigation data provider of the possible defect.

3. A method according to claim 1, characterized in that determining the possible defect based on the statistics comprises setting a threshold for the number of times that the actual behavior of the user differs from the computed route at the same location.

4. A method according to claim 1, characterized in that the navigation data comprises road network information.

5. A method according to claim 1, characterized in that the navigation data comprises additional information regarding driving conditions.

6. A method according to claim 1, characterized in that comparing the actual behavior of the user with the computed route is done continuously as the user proceeds towards the destination.

7. A method according to claim 1, characterized in that comparing the actual behavior of the user with the computed route is done after the guidance procedure.

8. A method according to claim 1, characterized in that the method further comprises the step of sending an update from the receiving unit to the navigation device.

9. A navigation device for guiding the user from the current location to a destination, the navigation device (14) being capable of executing a software application and arranged to communicate with a positioning module (13) for receiving the current location of the device, the navigation device comprising a navigation database including navigation data, and which navigation device is further arranged to:
compute a route from the current position to a destination upon a request; and
guide the user of the navigation device according to said computed route;
characterized in that the device is further arranged to:
compare the actual behavior of the user with the computed route;
detect at least one difference between the actual behavior of the user and the computed route;
send detected differences to a receiving unit (15);
collect the differences at the receiving unit (15); and
determine based on the statistics the possible defects in the navigation data.

10. A navigation device according to claim 9, characterized in that the navigation device is further arranged to notify the navigation data provider of the possible defect.

11. A navigation device according to claim 9, characterized in that when determining the possible defect based on the statistics, the navigation device is further arranged to set a threshold for the number of times that the actual behavior of the user differs from the computed route at the same location.

12. A navigation device according to claim 9, characterized in that the navigation data comprises road network information.

13. A navigation device according to claim 9, characterized in that the navigation data comprises additional information regarding driving conditions.

14. A navigation device according to claim 9, characterized in that the navigation device is further arranged to compare the actual behavior of the user with the computed route continuously as the user proceeds towards the destination.

15. A navigation device according to claim 9, characterized in that the navigation device is further arranged to compare the actual behavior of the user with the computed route after the guidance procedure is completed.

16. A navigation device according to claim 9, characterized in that the navigation device is further arranged to receive an update from the receiving unit.

17. A navigation software application for detecting defects in navigation data in a navigation device comprising navigation data, and wherein the navigation device has data communication means for communicating with other devices, the software application, when executed in a navigation device, arranged to perform the following steps of:
computing a route from the current position to a destination upon request; and
guiding the user of the navigation device according to said computed route;
characterized in that the software is further arranged to perform steps of:
comparing the actual behavior of the user with the computed route;
detecting at least one difference between the actual behavior of the user and the computed route;
sending detected differences to a receiving unit;
collecting the differences at the receiving unit; and
determining based on the statistics the possible defects in the navigation data.

18. A navigation software application according to claim 17, characterized in that the navigation software application is arranged to notify provider of the navigation data of the possible defect.

19. A navigation software application according to claim 17, characterized in that when determining the possible defect based on the statistics the navigation software application is further arranged to set a threshold for the number of times that the actual behavior of the user differs from the computed route at the same location.

20. A navigation software application according to claim 17, characterized in that the navigation data comprises road network information.

21. A navigation software application according to claim 17, characterized in that the navigation data comprises additional information regarding driving conditions.

22. A navigation software application according to claim 17, characterized in that the navigation software application is further arranged to compare the actual behavior of the user with the computed route continuously as the user proceeds towards the destination.

23. A navigation software application according to claim 17, characterized in that the navigation software application is further arranged to compare the actual behavior of the user with the computed route after the guidance procedure is completed.

24. A navigation software application according to claim 17, characterized in that the that the navigation software application is further arranged to retrieve an update from the receiving unit.

25. A navigation system for guiding the user from the current location to a destination comprising:
a navigation server (15) arranged to receive and send navigation related information from a plurality of navigation devices;
a navigation device (14) being capable of executing a software application and arranged to communicate with a positioning module (13) for receiving the current location of the device and the navigation server (14) for sending and receiving navigation data, the navigation device comprising a navigation database including navigation data and which navigation device is further arranged to:
compute a route from the current position to a destination upon a request; and
guide the user of the navigation device according to said computed route;
characterized in that the system is further arranged to:
compare the actual behavior of the user with the computed route;
detect at least one difference between the actual behavior of the user and the computed route;
send detected differences to a receiving unit (15);
collect the differences at the receiving unit (15); and
determine based on the statistics the possible defects in the navigation data.
